(19) United States
(12) Patent Application Publication
(10) Pub. No.: US 2008/0242766 A1
(43) Pub. Date: Oct. 2, 2008

(54) Curable Composition Containing Surface-Modified Particles

(75) Inventors: Christoph Briehn, Munchen (DE); Volker Stanjek, Munchen (DE); Richard Weidner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: CONSORTIUM FUER ELEKTROCHEMISCHE INDUSTRIE GMBH, Munich (DE)

(21) Appl. No.: 10/599,285

(22) PCT Filed: Mar. 10, 2005
(86) PCT No.: PCT/EP2005/002541

§ 371 Date: Sep. 25, 2006

(30) Foreign Application Priority Data
Mar. 25, 2004 (DE) 10 2004 014 686.1

(51) Int. Cl. C08K 7/00

(52) U.S. Cl. 523/203

(57) ABSTRACT

Coating compositions having reproducible properties and high scratch resistance contain an ethylenically unsaturated binder and particles functionalized with an alkoxysilane, the silicon atom of which is spaced from an electron withdrawing group by a methylene group.

The invention relates to curable compositions comprising a binder that carries at least one ethylenically unsaturated group and also particles which possess at least one ethylenically unsaturated group on their surface, and also to the use of these compositions for coating.

Free-radically curable coating compositions which comprise nanoscale fillers surface-modified with organic radicals and which cure to coatings of high mechanical hardness and chemical resistance are known. With coating compositions of this kind an appropriate modification of the particle surface ensures compatibility of the particle with the surrounding polymer matrix. Where the particle surface possesses, moreover, a suitable reactivity for the matrix, so that it is able to react with the binder system under the particular curing conditions of the coating system, it is possible to incorporate the particles chemically into the matrix in the course of curing, which has a frequently positive effect on the profile of properties of the composite system.

Free-radically curable, particle-reinforced coating compositions are described inter alia in U.S. Pat. No. 4,455,205 A and U.S. Pat. No. 4,491,508 A and are obtained by, for example, reacting colloidal silicon dioxide with 3-methacryloyloxypropyltrimethoxysilane and subsequently exchanging the aqueous and/or alcoholic solvent for a free-radically crosslinkable organic binder. Coating compositions of this kind can be used, for example, for coating thermoplastic substrates.

U.S. Pat. No. 6,306,502 B discloses coating compositions for scratchproof coatings that can be prepared from colloidal silicon dioxide and a free-radically polymerizable silane. The binder used in that case is a (meth)acryloyloxyalkyl-functional isocyanurate. DE 102 00 928 A1 describes curable organic dispersions comprising surface-modified nanoparticles prepared, for example, by mixing hydrophilic pyrogenic silicon dioxide, after a dispersing step in dipentaerythritol pentaacrylate, with 3-methacryloyloxypropyltrimethoxysilane, aluminum butoxide, and water. Dispersions of that kind can be used as coating materials, adhesives, and sealants.

The disadvantages of the known particle-containing binder systems are based predominantly in their preparation. In accordance with the prior art the particles contained in the coating systems are prepared by reacting particles possessing free silicon hydroxide (SiOH) or metal hydroxide (MeOH) functions with alkoxysilanes which contain as their reactive organic function an ethylenically unsaturated group, such as vinyl, (meth)acryloyl, etc. A feature common to all of the alkoxysilanes used for particle functionalization in the prior art is that they possess only a moderate reactivity toward the SiOH and/or MeOH groups of the particles to be modified. The surface functionalization of the particles is therefore slow and/or incomplete.

This is true in particular for monoalkoxy-functional silanes, whose reactivity is so low that they are usually completely unsuitable for functionalizing particles. And yet in certain cases the use of monofunctional alkoxysilanes would be particularly desirable, since, given sufficient reactivity, they would be consumed completely by reaction with the SiOH and/or MeOH groups, even without addition of water, and only equimolar quantities of the silanes would be needed in order to saturate all of the SiOH and/or MeOH groups of the particle. Where di- or trialkoxysilanes are used for surface functionalization, a siloxane shell is formed around the particles in the presence of water, after the hydrolysis and condensation of the silanols obtained. A problem here can be the fact that, when silanes of low hydrolytic and condensation reactivity are employed, the siloxane shell that is formed still possesses a large number of SiOH functions on the surface. The stability of SiOH-functional particles of this kind is restricted under the conditions of preparation and storage, even in the presence of the binder. There may be aggregation and agglomeration of the particles.

If reactive monoalkoxysilanes are used, in contrast, no silane shell is built up around the particle, consisting of silane molecules crosslinked with one another; instead, there is direct attachment of the silanes to the MeOH and/or SiOH groups of the particle. Moreover, the use of monomethoxysilanes permits particle functionalization even in the absence of water. In that case, in a stoichiometric reaction, virtually all of the MeOH and/or SiOH groups on the surface of the particle can be saturated with silane. Remaining MeOH and/or SiOH groups, which may restrict the stability of the particles, are therefore largely avoidable.

WO 03/18658 and WO 03/14226 functionalize organopolysiloxanes and also organic polymers by using functionalized alkoxysilanes which are distinguished by the fact that the alkoxysilyl group is separated by a methylene spacer from a heteroatom, oxygen or nitrogen for example, and, as a result of the spatial vicinity of these two groups, the reactivity of the silanes in respect of hydrolysis and condensation of the silyl unit is increased considerably. The increased reactivity of silanes of this kind having a methylene spacer is also described in Monatsh. Chem. 2003, 134, 1081-1092.

Highly reactive silanes of this kind have been employed to date to prepare silane-functional (pre-)polymers which have a correspondingly increased reactivity with respect to moisture and can therefore be used to produce compositions which cure by atmospheric moisture.

As a further problem of the coatings prepared in accordance with the prior art, these coatings frequently lack reproducible properties. In addition, further improvements in the coating properties—in particular, higher mechanical hardnesses and a further-improved scratch resistance of the coatings—would be desirable.

The object on which the present invention is based is that of providing a coating system which is curable with actinic radiation or thermally, which does not have the abovementioned disadvantages of the known systems and which, furthermore, is characterized by a profile of properties of the cured coatings that is an improvement on the known systems.

The invention provides curable compositions Z comprising a binder BM that carries at least one ethylenically unsaturated group and also particles P which possess at least one ethylenically unsaturated group on their surface and contain radicals of the general formula I,

≡Si—CR³₂-A-D-C (I),
where
R³ is hydrogen or hydrocarbon radical having 1 to 12 carbon atoms, whose carbon chain can be interrupted by nonadjacent oxygen, sulfur or NR⁴ groups,
R⁴ is hydrogen or hydrocarbon radical having 1 to 12 carbon atoms,
A is oxygen, sulfur, ═NR⁴ or ═N-(D-C),
D is carbonyl group, alkylene, cycloalkylene or arylene radical having in each case 1 to 12 carbon atoms, it being possible for the carbon chain to be interrupted by nonadjacent oxygen, sulfur or NR⁴ groups, and
C is an ethylenically unsaturated group.

The curable compositions Z comprise particles P which are surface-modified by means of the reactive radicals of the general formula I containing ethylenically unsaturated group, the reactive radicals being distinguished by the fact that the silyl group is separated from a heteroatom by a methylene spacer. The curable compositions Z therefore have precisely reproducible properties.

The particles P are preferably preparable by reacting
(a) particles P1 of a material selected from metal oxides, metal-silicon mixed oxides, silicon dioxide, colloidal silicon dioxide and organopolysiloxane resins and combinations thereof, and possessing functions selected from Me-OH, Si—OH, Me-O-Me, Me-O—Si—, Si—O—Si, Me-OR¹ and Si—OR¹,
(b) with organosilanes B of the general formula II,

(R¹O)₃₋ₙ(R²)ₙSi—CR₂³-A-D-C (II),
and/or their hydrolysis and/or condensation products,
(c) and optionally with water,
   where
R¹ is hydrogen or hydrocarbon radical having 1 to 6 carbon atoms, whose carbon chain can be interrupted by nonadjacent oxygen, sulfur or NR⁴ groups,
R² is hydrocarbon radical having 1 to 12 carbon atoms, whose carbon chain can be interrupted by nonadjacent oxygen, sulfur or NR⁴ groups,
Me is a metal atom and
n denotes the values 0, 1 or 2, and
R³, A, D, and C are as defined above.

The particles P are likewise preferably preparable by cohydrolyzing organosilanes B of the general formula II with alkoxysilanes B* of the general formula III,

(R⁵O)₄₋ₘ(R⁶)ₘSi (III),
where
R⁵ has the definitions of R¹,
R⁶ is hydrocarbon radical which can be substituted, and
m denotes the values 0, 1, 2 or 3.

The hydrocarbon radical R¹ is preferably an alkyl, cycloalkyl or aryl radical, especially methyl, ethyl or phenyl radical, more preferably a methyl or ethyl radical. R² is preferably an alkyl, cycloalkyl, aryl or arylalkyl radical, especially methyl, ethyl or phenyl radical, more preferably a methyl radical. R³ is preferably hydrogen or alkyl, cycloalkyl, aryl or arylalkyl radical, especially methyl radical, and with particular preference the radicals R³ are hydrogen. n preferably adopts the value 0 or 2. In one particularly preferred embodiment of the invention n adopts the value 2. The group C is preferably an unsaturated alkyl radical having 2 to 12 carbon atoms, more preferably having 2 to 6 carbon atoms, especially vinyl, acryloyl or methacryloyl. The groups (-A-D-C) are preferably the following radicals: OC(O)C(CH₃)═CR³₂, OC(O)CH═CR³₂, NHC(O)C(CH₃)═CR³₂ or NHC(O)CH═CR³₂. With particular preference they are the radicals OC(O)C(CH₃)═CR³₂ or OC(O)CH═CR³₂. Preferred radicals for R⁵ are listed for the preferred radicals R¹. R⁶ is preferably a functionalized or nonfunctionalized e.g. aromatic or aliphatic saturated or unsaturated hydrocarbon radical having 1 to 12 carbon atoms. Preferred radicals for R⁶ are listed for the preferred radicals R² and. R⁶ may also adopt the definition CR³₂-A-D-C; i.e., in that case organosilanes B of the general formula II are identical with alkoxysilanes B*.

Preferred examples of alkoxysilanes B* are tetraethoxysilane, tetramethoxysilane, methyltrimethoxysilane, dimethylmethoxysilane, phenylmethyldimethoxysilane, phenyltrimethoxysilane, and vinyltrimethoxysilane.

The compositions Z are used preferably as coatings. With particular preference they serve in this context to improve the scratch resistance of the coated surface. The coatings obtainable from compositions Z by curing have a higher mechanical hardness and improved scratch resistance than comparable coatings containing particles surface-modified with conventional, only moderately reactive silanes and/or their hydrolysis and/or condensation products.

In view of the high reactivity of the alkoxysilanes B having a methylene spacer between alkoxysilyl group and a heteroatom, these compounds are particularly suitable for functionalizing particles P1 which carry SiOH or MeOH. The equilibration of the Me-O-Me-, Me-O—Si—, and Si—O—Si-functional particles with the alkoxysilanes B is made easier by the high reactivity as well, and can be carried out for the preparation of the particles P. The reactions of the particles P1 with the alkoxysilanes B are rapid and complete.

The binder BM contained in the compositions Z must carry one or more reactive groups which, preferably initiated by actinic radiation or thermal treatment, are capable of free-radical, cationic or anionic polymerization, with construction of a polymer, with themselves and with the reactive particles. Reactive groups are groups containing ethylenically unsaturated functions, especially vinyl groups, methacrylate groups, acrylate groups and acrylamide groups. The binder BM may comprise in this context monomeric, oligomeric or else polymeric compounds.

Examples of suitable monomeric and oligomeric compounds are hexanediol diacrylate, pentaerythritol triacrylate, dipentaerythritol pentaacrylate, triethylene glycol diacrylate, etc. Examples of suitable polymeric binders BM are ethylenically unsaturated group-carrying (meth)acrylic copolymers, polyester (meth)acrylates, unsaturated polyesters, urethane (meth)acrylates, and silicone (meth)acrylates.

By actinic radiation is meant electromagnetic radiation in the infrared (NIR), in the visible, in the ultraviolet (UV), and also in the region of X-radiation.

The compositions Z are notable for the fact that use is made as particles P1 of all metal oxide and metal mixed oxide particles (e.g., aluminum oxides such as corundum, aluminum mixed oxides with other metals and/or silicon, titanium oxides, zirconium oxides, iron oxides, etc.), silicon oxide particles (e.g., colloidal silica, pyrogenic silica, precipitated silica, silica sols) or silicon oxide compounds in which some valences of the silicon have been provided with organic radicals (e.g., silicone resins). The particles P1 are notable, furthermore, for the fact that on their surface they possess metal hydroxide (MeOH), silicon hydroxide (SiOH), Me-O-Me, Me-O—Si and/or Si—O—Si functions via which reaction can take place with the organosilanes B. The particles P1 possess preferably an average diameter of less than 1000 nm, more preferably less than 100 nm, the particle size being determined by transmission electron microscopy.

In one preferred embodiment of the invention the particles P1 are composed of pyrogenic silica. In a further preferred embodiment of the invention the particles P1 used are colloidal silicon oxides or metal oxides which are preferably in the form of a dispersion of the corresponding oxide particles of submicron size in an aqueous or organic solvent. In this context it is possible with preference to use the oxides of the metals aluminum, titanium, zirconium, tantalum, tungsten, hafnium, and tin. Preference is given to using aqueous SiO₂ sols which are reacted preferably with organosilanes B of the general formula II in which n=2.

Likewise employed with preference, moreover are particles P1 which are composed of silicone resins of the general formula IV

(R⁷₃SiO_{1/2})ₑ(R⁷₂SiO_{2/2})_{f}(R⁷SiO_{3/2})_{g}(SiO_{4/2})ₕ (IV)

where
R⁷ is an OR⁸ function, an OH function, an optionally halogen-, hydroxyl-, amino-, epoxy-, thiol-, (meth)acryloyl- or NCO-substituted hydrocarbon radical having 1-18 carbon atoms, it being possible for the carbon chain to be interrupted by nonadjacent oxygen, sulfur or NR⁴ groups,
R⁸ is an optionally substituted monovalent hydrocarbon radical having 1-18 carbon atoms,
e denotes a value of greater than or equal to 0,
f denotes a value of greater than or equal to 0,
g denotes a value of greater than or equal to 0, and
h denotes a value of greater than or equal to 0, with the proviso that the sum of e+f+g+h is at least 1, preferably at least 5.

For the compositions Z it is possible to use one or more different particle types P. Thus it is possible, for example, to prepare coating systems which in addition to nanoscale SiO₂ also include nanoscale corundum.

The amount of the particles P contained in the coating system, based on the overall weight, is preferably at least 5% by weight, more preferably at least 10% by weight, very preferably at least 15% by weight, and preferably not more than 90% by weight.

The compositions Z are prepared preferably in a two-stage process. In the first stage the particles P are prepared. In the second step the functionalized particles P are introduced into the binder BM.

In one preferred process the particle P obtained by reacting the particle P1 with the organosilane B is purified before being introduced into the binder BM. This approach is especially advisable when the impurities occurring in the preparation process have an adverse effect on the profile of properties of the cured coating. The particles P can be purified, for example, by precipitating the particle and then washing it with a suitable solvent.

In an alternative process the composition Z is prepared by functionalizing the particles P1 with the silanes B in the presence of the binder BM. In both preparation processes the particles P1 may be present either as a dispersion in an aqueous or else anhydrous solvent and in the solid state.

Where aqueous or nonaqueous dispersions of the particles P1 are used, the corresponding solvent is generally removed after the particles P or P1 have been introduced into the binder BM. The removal of the solvent is preferably accomplished distillatively, and may take place before or after the reaction of the particles P1 with the silanes B.

Examples of silanes B employed with preference are acryloyloxymethyltrimethoxysilane, acryloyloxymethylmethyldimethoxysilane, acryloyloxymethyldimethylmethoxysilane, acryloyloxymethyltriethoxysilane, acryloyloxymethylmethyldiethoxysilane, acryloyloxymethyldimethylethoxysilane, methacryloyloxymethyltrimethoxysilane, methacryloyloxymethylmethyldimethoxysilane, methacryloyloxymethyldimethylmethoxysilane, methacryloyloxymethyltriethoxysilane, methacryloyloxymethylmethyldiethoxysilane and methacryloyloxymethyldiethylmethoxysilane.

In one particularly preferred embodiment of the invention the silanes B used are monoalkoxysilyl-functional silanes of the general formula (II) with n=2, such as (meth)acryloyloxymethyldimethylmonomethoxysilane or (meth)acryloyloxymethyldimethylmonoethoxysilane.

For the functionalization of the particles it is possible to employ one silane B individually or a mixture of different silanes B or else a mixture of silanes B with other alkoxysilanes.

The compositions Z may, furthermore, comprise common solvents and also the additives and adjuvants that are typical in formulations. Examples of these would include flow control assistants, surface-active substances, adhesion promoters, light stabilizers such as UV absorbers and/or free-radical scavengers, thixotropic agents, and also further solids and fillers. To produce the particular desired profiles of properties both for the compositions and for the cured materials, adjuvants of this kind are preferred. This is true especially when the compositions Z are to be used as coatings. These coating formulations may additionally comprise dyes and/or pigments as well.

The curing of the composition Z is accomplished preferably by actinic radiation or thermally initiated free-radical polymerization under the conditions necessary for ethylenically unsaturated groups, in a conventional way known to the skilled worker.

The polymerization takes place, for example, by UV irradiation following addition of suitable photoinitiators such as Darocur® 1178, Darocur® 1174, Irgacure® 184, Irgacure® 500, for example. These photoinitiators are used typically in amounts of 0.1%-5% by weight. The polymerization can be carried out thermally following addition of organic peroxides, such as peroxydicarboxylic acids, or azo compounds, such as azobisisobutyronitrile, for example.

In one particularly preferred embodiment of the invention the compositions Z comprise at least one photoinitiator and the coating is cured by UV radiation. In a further particularly preferred embodiment of the invention the compositions Z are cured by electron beams.

The coatings obtained after the compositions Z have been cured possess outstanding mechanical properties. In comparison to known materials there is a significant improvement in, for example, the scratch resistance.

The invention further provides for the use of the compositions Z for coating any desired substrates. Examples of preferred substrates include oxidic materials, such as glass, for example, metals, wood or plastics such as polycarbonate, polybutylene terephthalate, polymethyl methacrylate, polystyrene, polyvinyl chloride, and polypropylene.

The applied coatings serve to improve the scratch resistance, abrasion resistance, chemical stability or else to influence the abhesive properties.

The compositions Z can be applied by any desired techniques such as dipping, spraying, and casting. Application by a “wet on wet” method is also possible.

All symbols in the above formulae have their definitions in each case independently of one another. In all formulae the silicon atom is tetravalent.

In the examples below, all amounts and percentages are by weight, and all pressures are 0.10 MPa (abs.) and all temperatures are 20° C., unless indicated otherwise.

### EXAMPLE 1

20.00 g of an SiO₂ organosol (IPA-ST® from Nissan Chemicals, 30% by weight SiO₂, 12 nm) are admixed dropwise over the course of 1 minute with 2.00 g of methacrylatomethyldimethylmethoxysilane and the mixture is heated at 60° C. for 16 hours. After the mixture is cooled to room temperature, 15.00 g of hexanediol diacrylate are added and then the isopropanol is distilled off under reduced pressure. The transparent dispersion contains 29% by weight of SiO₂.

### EXAMPLE 2

20.00 g of an SiO₂ organosol (IPA-ST® from Nissan Chemicals, 30% by weight SiO₂, 12 nm) are admixed dropwise over the course of 1 minute with 0.66 g of methacrylatomethyldimethylmethoxysilane and the mixture is heated at 60° C. for 16 hours. After the mixture is cooled to room temperature, 15.00 g of hexanediol diacrylate are added and then the isopropanol is distilled off under reduced pressure. The transparent dispersion contains 29% by weight of SiO₂.

### EXAMPLE 3

20.00 g of an aqueous SiO₂ sol (LUDOX® AS 40 from Grace Davison, 40% by weight SiO₂, pH=9.1, 22 nm) are admixed dropwise over the course of 60 minutes with 20 ml of ethanol and over 5 minutes with 2.00 g of methacrylatomethyltrimethoxysilane and the mixture is heated at 60° C. for 16 hours. After the mixture is cooled to room temperature, 15.00 g of hexanediol diacrylate are added and then ethanol and water are distilled off as an azeotrope. The transparent dispersion contains 35% by weight of SiO₂.

### EXAMPLE 4

20.00 g of an aqueous SiO₂ sol (LUDOX® AS 40 from Grace Davison, 40% by weight SiO₂, pH=9.1, 22 nm) are admixed dropwise over the course of 60 minutes with 15 ml of ethanol and over 5 minutes with 2.00 g of methacrylatomethyldimethylmethoxysilane and the mixture is heated at 60° C. for 16 hours. After the mixture is cooled to room temperature, 15.00 g of hexanediol diacrylate are added and then ethanol and water are distilled off as an azeotrope. The transparent dispersion contains 29% by weight of SiO₂.

### EXAMPLE 5

20.00 g of an SiO₂ organosol (IPA-ST® from Nissan Chemicals, 30% by weight SiO₂, 12 nm) are admixed dropwise over the course of 1 minute with 2.00 g of methacrylatomethyldimethylmethoxysilane and the mixture is heated at 60° C. for 16 hours. After the solvent has been distilled off, the residue is washed with 100 ml (5×20 ml) of pentane. A dispersion of 2.90 g of the resulting solid in 10 ml of ethanol is admixed with 7.10 g of HDDA and the solvent is distilled off. This gives a transparent dispersion having an SiO₂ content of 29% by weight.

### COMPARATIVE EXAMPLE 1

26.7 g of an SiO₂ organosol (IPA-ST® from Nissan Chemicals, 30% by weight SiO₂, 12 nm) are admixed over the course of 1 minute with 15.00 g of hexanediol diacrylate, the mixture is stirred for 30 minutes and then the isopropanol is distilled off under reduced pressure. The transparent dispersion contains 35% by weight of SiO₂.

### COMPARATIVE EXAMPLE 2

A mixture of 20.00 g of an SiO₂ organosol (IPA-ST® from Nissan Chemicals, 30% by weight SiO₂, 12 nm) and 10 g of water is admixed dropwise over the course of 1 minute with 2.00 g of methacrylatopropyltrimethoxysilane. The mixture is heated at 60° C. for 16 hours. After the mixture is cooled to room temperature, 15 g of hexanediol diacrylate are added and then isopropanol and water are distilled off azeotropically. The transparent dispersion contains 29% by weight of SiO₂.

### EXAMPLE 6

### Production of coating films

The coating materials from examples 1, 2, 3, 4, and 5, and from comparative examples 1 and 2, and also a coating composed of pure 1,6-hexanediol diacrylate, are each applied to a glass plate using a Coatmaster® 509 MC film-drawing apparatus from Erichsen, with a coating bar with a slot height of 80 μm. Thereafter the resulting coating films are cured under nitrogen in a UVA cube, model UVA-Print 100 CV1 from Dr. Hönle, with a lamp output of about 60 mW/cm², with an irradiation period of 60 seconds. All of the coating formulations produce visually attractive and smooth coatings. The gloss of all five coatings—as determined with a Micro gloss 20° gloss meter from Byk—was approximately 155 gloss units for all 6 coating materials.

### EXAMPLE 7

### Evaluation of the Scratch Resistance of Coating Films

The scratch resistance of the coating films produced in accordance with example 6 was determined using a Peter-Dahn abrasion-testing instrument. For this purpose a Scotch Brite® 07558 abrasive nonwoven with an area of 45×45 mm is loaded with a weight of 1 kg and scratched using 500 strokes. Both before the beginning and after the end of the scratch tests the gloss of the respective coating is measured using a Micro gloss 20° gloss meter from Byk. As a measure of the scratch resistance of the respective coating the loss of gloss is ascertained (average value from 3 coating samples in each case):

TABLE 1
Loss of gloss in the Peter-Dahn scratch test

| Coating sample | Loss of gloss |
|---|---|
| Example 1 | 15 ± 4% |
| Example 2 | 27 ± 6% |
| Example 3 | 25 ± 5% |
| Example 4 | 10 ± 5% |
| Example 5 | <5% |
| Comparative example 1 | 78 ± 7% |
| Comparative example 2 | 43 ± 5% |
| 1,6-Hexanediol diacrylate | 75 ± 10% |

1-10. (canceled)

11. A curable composition comprising a binder bearing at least one ethylenically unsaturated group, and functionalized particles which possess at least one ethylenically unsaturated group and contain radicals of the formula I,
≡Si—CR³₂-A-D-C (I),
where the particles are prepared by reacting
(a) particles of a metal oxide, metal-silicon mixed oxide, silicon dioxide, colloidal silicon dioxide, organopolysiloxane resin or combination thereof, the particles possessing functionality selected from Me-OH, Si—OH, Me-O-Me, Me-O—Si—, Si—O—Si, Me-OR¹ and Si—OR¹, and having an average diameter of less than 1000 nm,
(b) with organosilanes of the general formula II,
(R¹O)₃₋ₙ(R²)ₙSi—CR³₂-A-D-C (II),
their hydrolysis or condensation products, or mixtures thereof, and
where
(c) and optionally water,
R¹ is hydrogen or a hydrocarbon radical having 1 to 6 carbon atoms, whose carbon chain is optionally interrupted by nonadjacent oxygen, sulfur or NR⁴ groups,
R² is a hydrocarbon radical having 1 to 12 carbon atoms, whose carbon chain is optionally interrupted by nonadjacent oxygen, sulfur or NR⁴ groups,
R³ is hydrogen or a hydrocarbon radical having 1 to 12 carbon atoms, whose carbon chain is optionally interrupted by nonadjacent oxygen, sulfur or NR⁴ groups,
R⁴ is hydrogen or a hydrocarbon radical having 1 to 12 carbon atoms,
A is oxygen, sulfur, ═NR⁴ or ═N-(D-C),
D is a carbonyl group, or an alkylene, cycloalkylene or arylene radical having 1 to 12 carbon atoms, the carbon chain optionally interrupted by nonadjacent oxygen, sulfur or NR⁴ groups,
C is an ethylenically unsaturated group,
Me is a metal atom, and
n is 0, 1 or 2.

12. The composition of claim 11, wherein the particles are selected from pyrogenic silica, colloidal silica, and silicone resins.

13. The composition of claim 11, wherein the hydrocarbon radical R¹ is a methyl, ethyl or phenyl radical.

14. The composition of claim 11, wherein at least one group (-A-D-C) is a radical OC(O)C(CH₃)═CR³₂, OC(O)CH═CR³₂, NHC(O)C(CH₃)═CR³₂, or NHC(O)CH═CR³₂.

15. The composition of claim 11, wherein the ethylenically unsaturated groups in the binder are capable of free-radical, cationic or anionic polymerization.

16. The composition of claim 11, wherein the ethylenically unsaturated groups in the binder are polymerizable by actinic radiation or thermal treatment.

17. The composition of claim 11, wherein the ethylenically unsaturated groups in the binder are selected from vinyl groups, methacrylate groups, acrylate groups, acrylamide groups, and mixtures thereof.

18. The process for coating a substrate, comprising applying to a surface of said substrate a composition of claim 11, and curing said composition.
